(19) United States
(12) Patent Application Publication
(10) Pub. No.: US 2013/0325620 A1
(43) Pub. Date: Dec. 5, 2013

(54) Consumer assistance systems

(71) Applicant: Brian B. Walker, Big Lake, MN (US)

(72) Inventor: Brian B. Walker, Big Lake, MN (US)

(21) Appl. No.: 13/815,072

(22) Filed: Jan. 29, 2013

Related U.S. Application Data
(60) Provisional application No. 61/689,208, filed on May 31, 2012.

(51) Int. Cl. G06Q 30/06

(52) U.S. Cl. CPC G06Q 30/0623
USPC 705/14.64

(57) ABSTRACT

A system for aiding either or both a consumer or an establishment where a consumer in an establishment can obtain timely on site information through communication between a consumer hand held cellular device and a computer kiosk and the on site information may be communicated to a remote control station through a wireless cellular network to enable on the go individualized presentation of requested or relevant information to the consumer to thereby benefit both the consumer and the establishment.

### CROSS REFERENCE TO RELATED APPLICATIONS

This application claims priority from provisional application Ser. No. 61/689,208 filed May 31, 2012.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Consumer products are typically sold at neighborhood stores as well as through online marketers. In neighborhood stores the consumer and the operator of the store share a common goal in that both need to be satisfied, a consumer may need information on a product or service and a store operator needs to be able to present products and services as well as information to the consumer so that the consumer becomes knowledgeable about the product or service. If the consumer becomes knowledgeable about the products or services the more likely the consumer will purchase the product or service. In this scenario both the consumer and the store operator benefit when a knowledgeable consumer purchases the product or service from the store operator.

One of the difficulties a consumer faces is obtaining relevant information or data on a product or service to enhances the consumer's knowledge and thus enable the consumer make a knowledgeable purchase. In addition, once product or service information is obtained there may be related information that would benefit the consumer, however, the consumer may not recognize the need for the related information based on the consumers known information. A feature of the invention described herein is that the system provides a convenient way to present not only requested information or data to the consumer but a way to provide related information to assist the consumer.

One of the disadvantages of a neighborhood store is that the neighborhood store is generally at a competitive disadvantage with an online retailer since an online retailer does not have to maintain products available for inspection. In addition, in most cases purchasers of products through online marketers do not pay a sales tax, which the neighborhood store must pay. A further disadvantage of the neighborhood store is that a certain portion of the purchasing public goers to the neighborhood store to view and examine the product. In some cases a person obtains or solicits information about the product from the salesperson in the neighborhood store. Each of these services offered by the neighborhood store must be factored into the price of goods sold. Some customers, who realize the benefit of the neighborhood store purchase from the neighborhood store even though the price may be cheaper from an online marketer. However, other potential customers may simply obtain the information, leave the store and order the product from an online marketer. If some of these potential customers, who review the product in the neighborhood store can be persuaded to purchase the product in the neighborhood store all the customers of the neighborhood store benefit since the neighborhood store can remain competitive. A feature of the invention described herein is that in response to product or service inquires from a consumer the system offers the neighborhood merchant an opportunity to provide requested information as well as related information to a potential customer who may then decide to purchase the product or service from the neighborhood store rather than online thereby lessening the losses to the neighborhood store.

Another problem that neighborhood merchants encounter is that a consumer product may not be selling quickly enough so that the products are reaching their expiration date and may have to be discarded, which adds to the overhead cost of the neighborhood merchant. A feature of the invention described herein is that it offers the neighborhood merchant an opportunity to promote a slow selling product so that the products can be sold before the expiration date. By reducing the price to the product the consumer benefits by paying less and the neighborhood merchant avoids loss due to spoilage.

A further feature of the invention described herein is that it enables a neighborhood merchant to emphasize sales of slow selling products by offering discounts on the slow selling products again benefiting both the consumer and the neighborhood merchant since the consumer obtains the products or services at a cheaper price and the neighborhood merchant sells the product before it becomes a loss item.

Still another problem encounter by neighborhood stores is that the sales personnel may be unskilled and lack the background and the information necessary to answer consumer questions on the consumer product causing a consumer to forego purchasing the product or service. A feature of the invention described herein is that it enables the neighborhood merchant to provide detail product information in response to a consumer inquiry as well as related information to the potential customer even though the sales person may not be knowledgeable about the product thus minimizing the chances the consumer will leave the store for another location.

Another problem that manufactures or instore establishments that sell consumer goods have is attracting the customer so the customer can be informed about the features and benefits of the product or service. Typically, static visual or audio displays may be used to attract the customer and inform the customer on the benefits and features of the product. However, the manufacture or the merchant does not know what features and benefits a consumer are interested and generally delivers a generic message that may or may not be helpful to the consumer. A feature of the invention is that the system is an open system that invites the consumer to request selected product and service information, which can then be delivered to the consumer thus benefiting both the consumer and the store operator.

### SUMMARY OF THE INVENTION

A system for aiding consumers and neighborhood stores in furthering common objectives by providing the consumer with on demand requested information as well as related information based on the requesters input. The system allows a consumer in an establishment to obtain timely on site information, which may be initiated through in store communication between the consumer's mobile hand held device and an instore computer kiosk. The instore communication may be relayed to a remote control station through a wireless cellular network where the cellular frequency is unique to the computer kiosk to enable on-site, timely, on-the-go individualized presentation of requested information and relevant information to the consumer from an off site source thus benefiting both the consumer and the establishment through the interactive use of onsite instore communication and offsite wireless cellular communication.

### BRIEF DESCRIPTION OF THE DRAWINGS

FIG. 1 shows a consumer with a hand held device located proximate a store kiosk;

FIG. 2 is a block diagram of a system of communication between the consumer and a remote processor; and

FIG. 3 is a block diagram of an alternate system of communication between the consumer and a remote processor.

### DESCRIPTION OF THE PREFERRED EMBODIMENT

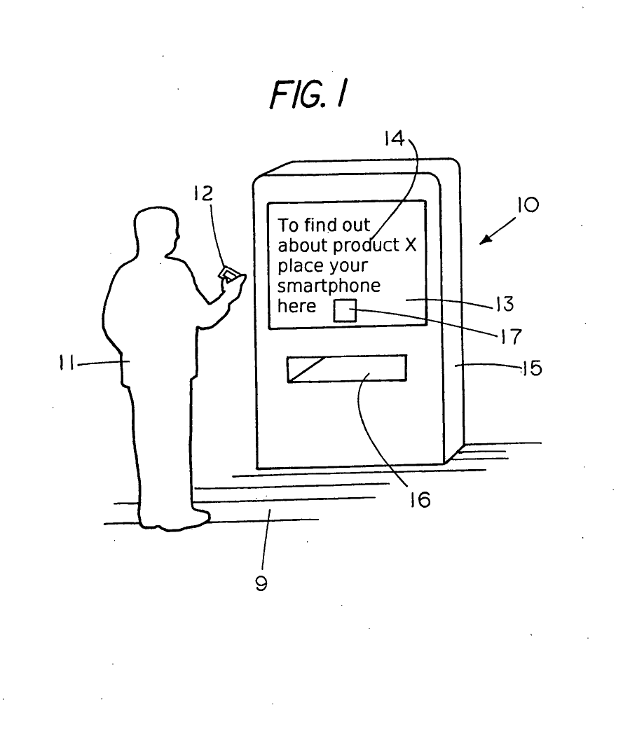

FIG. 1 shows an establishment, such as a neighborhood store 9 having a location for advertising goods and services. A consumer 11 holding a hand held device 12, for example, a smartphone having a visual display and an input/output device with the smartphone having instore communication technology comprising an NFC chip which may be an NFC transceiver for sending and receiving NFC signals from a free standing computer kiosk 10. Computer kiosk 10 includes a base 15 and a visual display 13. The visual display contains a prompt 14 that encourages the consumer to initiate action to obtain further product or service information by placing the mobile device 12, which has the NFC chip, proximate an NFC region 17 on visual display screen 13 to enable near field communication of the mobile device 12 with an NFC chip in computer kiosk 10. Placing the hand held or mobile device 12, which may for example be a smartphone, proximate region 17 brings the NFC chip in the smartphone 12 into NFC communication with the NFC transceiver in the computer kiosk 10. Typically, NFC communication is established in less than a tenth of a second and at distances of less than 20 centimeters thereby lessen chances of unwanted interception of information from the consumer's smartphone. As used herein the term mobile device is a device that contains an instore communication feature such as an NFC chip for sending information to an NFC chip in the computer kiosk. Preferably the NFC chip comprises an NFC transceiver that can both send and receive communications from the computer kiosk 10. The computer kiosk may or may not be free standing but is positioned so that it can be viewed by a person in the establishment. Similarly, the near field communication area or region 17 may be proximate a visual display 13 or it may be at another location where the instore customer can readily access with his or her hand held mobile device. The mobile device may or may not contain wireless cellular communication ability but does at least have an NFC chip to enable a consumer to interact with the NFC transceiver in the computer kiosk 12 by receiving information from the mobile device. Prompt 14 may be a message generated on the screen in response to the presence of a person proximate the kiosk 10 or it may be generated in response to other conditions. In either case the prompt 14 invites the consumer to initiate an action to obtain information through NFC communication. In operation the NFC transceiver in computer kiosk 10 communicates information to a processor in computer kiosk 10, which in turn can communicate with either or both visual display 13 and a remote control station. Once NFC communication is established between the computer kiosk 10 and the mobile device 12 the processor in the computer kiosk 10 can receive or deliver additional information on demand if the mobile device contains an NFC transceiver to communicate with the NFC transceiver in the computer kiosk 10. The additional information may be based on the information supplied from the NFC transceiver in mobile device 12 or be information obtained by sending an inquiry from the kiosk 10 to a remote processor over a cellular network. Once the information is sent to the processor in the kiosk 10 an action may be taken in kiosk 10, for example, if a person is interested in finding about a product a review of the product may be shown on the visual display 13. If the product is the type of product that consumers often inspect at a store but buy from an online retailer the computer kiosk can generate a special sale offer for the product. Thus, information can be delivered on-site, timely, on-the-go as well as individualized to the consumer. The special sale offer may be in form of a coupon that can only be used by the consumer with the hand held device and only in the neighborhood store during a limited time period thus providing an incentive to the customer to purchase the product while the customer is in the store. A further benefit is that when the processor in the kiosk 10 receives information on an interest in the product the processor can transmit a cellular wireless signal to the remote control station, which may be connected to the Internet. The remote control station may make additional relevant information available to the consumer based on the data transmitted by the consumer. For example, information that is based on the interest level of the consumer as well as the nature of the consumer request. The additional relevant information may be the type of information that is relevant to a product or service but the consumer may lack the knowledge to appreciate the relevancy of the information until the information is presented to the consumer.

In some cases the remote control station may have an application to determine the prices that competitors are currently charging for the same or similar product. Accordingly, based on current prices charged by competitors a special sale offer can be generated to the instore customer that is competitive with the price that online retailers are charging for similar or identical items. The special sale offer may be generated by information contained in the processor in the computer kiosk 10 or the processor in the computer kiosk 10 may send a request to a remote control station that enables a person at the remote control station to determine a price to offer the consumer. In either event it allows the instore establishment to become instantly competitive with on line marketers, which may be based on the interest shown by the consumer with the hand held mobile device. Another advantage is that the system allows the store to become instantly competitive and avoids situations where the consumer may leave the store when he discovers that an application on his or her smartphone determines the best price for a product or service is at another establishment. Thus the establishment enables the store to retain sales by become price competitive with other stores in the area.

Consequently, in response to consumer 11 initiating an NFC transfer of information to kiosk 12 a variety of actions can be initiated through the computer kiosk 12. As pointed out the product information may be displayed on the screen 13 with the product information including a coupon that may be printed and delivered to the consumer 11 through output basket 16 of computer kiosk 12 with the coupon based on the level of consumer interest in the product. In other examples the product information may include the benefits and features that a consumer obtains by purchasing the product in the establishment 9.

In another example the processor in the kiosk 12 initiates a NFC dialog with consumer 11 through a prompt on visual display screen 13. That is, NFC transceiver in the computer kiosk 10 sends an NFC signal to a transceiver in the hand held device 12. In response thereto the processor in the computer kiosk transmits information to the consumer 11 through either the visual display 13 or a speaker located in computer kiosk 12. In this example the NFC communication regarding the product is between the processor in the kiosk and a processor in hand held device 12. Thus the computer kiosk 10 in conjunction with the hand held device 12 provides an interactive display system in which the consumer becomes a part of the system.

Thus, the invention includes a system for aiding an establishment in competition with an online marketers wherein a consumer in the establishment can obtain timely on site information through NFC communication between a mobile device 12 and a computer kiosk 10 where the on site information may be communicated from a remote control station over a wireless cellular network and where the cellular frequency is unique to the computer kiosk 10 to thereby provide for a timely on-the-go individualized presentation of information that benefits both the consumer and the establishment. For example, the consumer obtains the information to help evaluate the product or service and the consumer may receive a discount that allows the consumer to obtain the product while the consumer is in the store and at a price competitive to an online retailer.

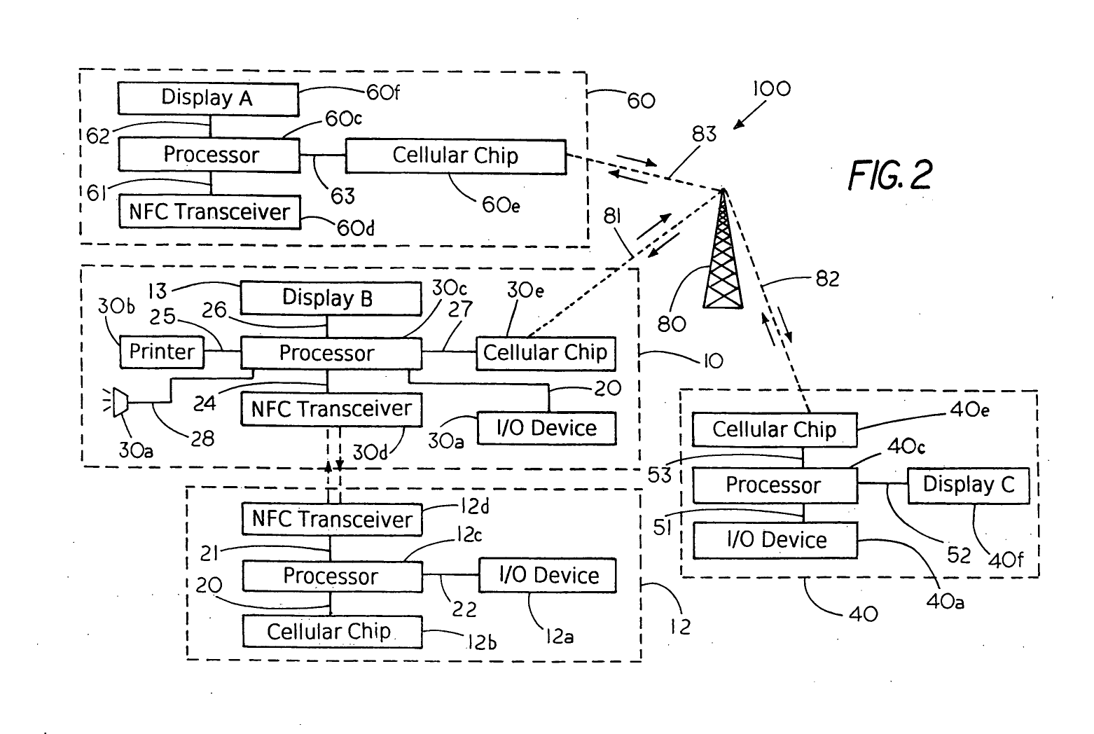

A reference to FIG. 2 shows a block diagram of a system 100 for responding to consumer requests as well as selectively or generally delivering information to a plurality of instore processors through a combination of cellular networks and NFC transceivers. System 100 includes a first instore computer kiosk 10, a hand held mobile device 12, a second instore computer kiosk 60 and an offsite control center 40 with offsite control center in communication with either or both computer kiosk 30 and computer kiosk 60 through a cellar network identified by cellular tower 80 and cellular signals 81, 82, and 83 which are being sent to and from cell tower 80. Through use of a specific cellular frequency each of the instore kiosks 10 or 60 are individually addressable from the control station 40. While only two kiosks are illustrated it is understood that numerous instore kiosks may be used with the system 100 with each of the kiosks individually addressable over a unique cellular frequency.

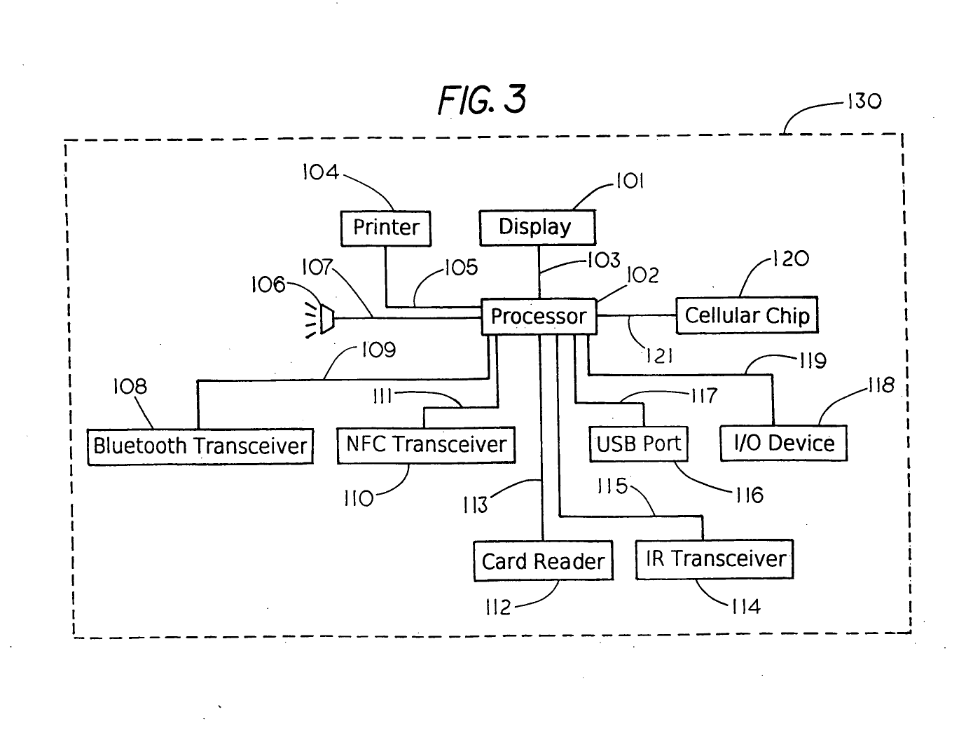

A reference to FIG. 3 shows a block diagram of a computer kiosk 130 for responding to consumer requests as well as selectively or generally delivering information to a plurality of instore processors through a number of on site communication technologies. The instore kiosk 130 includes a processor 102 which connects to a visual display 101 through lead 103. Processor 102 connects to a printer 104 through a lead 105 and to a speaker 106 through a lead 107. An I/O device, which for example may be a keyboard or a touch screen, allows a person proximate the kiosk the option of interacting directly with the computer kiosk 130. A cellular chip 120 that connects to processor 102 through lead 121 enables the computer kiosk 130 to communicate with a remote processor through a cellular network.

In the example shown in FIG. 3 multiple onsite transmission technologies are included in the computer kiosk 130 including a Bluetooth® transceiver 108 that connects to processor through lead 109 and a NFC transceiver 110 that connects to processor 102 though lead 111. Alternates wireless instore communication technologies may include a card reader 112 that connects to processor 102 through lead 113 and an IR (infra red) transceiver 114 that connects to processor 102 though lead 114. In addition, if desired, the computer kiosk can include a USB port 116 that connects to processor 102 through lead 117 to provide a cable connection between the computer kiosk and a mobile device. Thus the kiosk 130 includes a variety of instore communication technologies including Bluetooth® technology, NFC technology, card reader technology, infra red technologies or cable technology that can communicate with a mobile hand held device depending on the features of the mobile hand held device. As used herein the term Bluetooth® technology is used to identify if transmissions in the 2400 to 2480 MHZ frequency.

To appreciate the operation of the system reference should be made to FIG. 2 which shows how the various devices in the system 100 communicate with each other. In the example of FIG. 2 the hand held device 12, which may for example be a smartphone, contains a processor 12c which is in communication with a cellular chip 12b through lead 20 and NFC transceiver 12d through lead 21. An I/O device 21a such as keyboard or a touch screen connects to processor 12c though a lead 22 to enable the consumer 11 to input information to the processor 12c.

The computer kiosk 10, which is typically located in a neighborhood store, contains a processor 30c, which is in communication with a cellular chip 30e through lead 27 and NFC transceiver 30d through lead 24. Processor 30c connects to printer 30b though lead 25 and to display 30f through lead 26. An input/output, i.e. an I/O device 30a such as keyboard or a touch screen also connects to processor 30c though lead 20. A speaker 30g connects to processor 30b though lead 28 and visual display 13 connects to processor 30c though lead 26. In this example the I/O device may be a touch screen so that the consumer has the option of further inquiry directly with the processor 30c in the kiosk 10.

FIG. 2 also shows a second computer kiosk 60, which is typically located in another neighborhood store at a different location. Kiosk 60 contains processor 60c, which connects to a display 60f through a lead 62 and to NFC transceiver 60d through lead 61. A cellular chip 60e connects to processor 60c through lead 63. The processor 60c communicates with the remote control station 40 though a cellular signal 83 and 82 from cell tower 80 or with the kiosk 10 through an NFC chip in the kiosk and an NFC chip in the mobile hand held device 12.

In the example shown the remote control station 40 includes a processor 40c, which connects to a cellular chip 40e through lead 53 and to an I/O device 40a through lead 51. A display 40f also connects to processor 40c though lead 52 to allow the remote operator in remote station 40 to observe what is being displayed at kiosk 10.

The invention includes an interactive display system 100 comprising an establishment 9 having at least one location for advertising goods and services and a control center 40 located remote from establishment 9. In the example shown at least one electronic or visual display 13 is located proximal a location for displaying goods and services in the establishment 9. The display 13 shows consumer information such as images, videos, and audios therefrom, with the kiosk 12 having a cellular transceiver 30e wirelessly connecting display 13 with control center 40 to transmit and receive information therefrom through a unique cellular frequency between cellular chip 30e and cellular chip 40e. That is kiosk 10 and remote station 40 each have their own unique telephone numbers so communications can be directed therebetween. The hand held user device 12 contains a processor 12c and an instore communication device such as a near field communication device 12d for communicating with the near field communication device 30d to provide a consumer with additional consumer information. The use of the near field communication between the consumer and the establishment computer enables the consumer to avoid wide dissemination of personal information on his or her hand held mobile device since the information is only obtainable if a receiver is within a few centimeters of the hand held mobile device.

If the computer kiosk 130 of FIG. 3 is used a variety of instore wireless communication technologies such as Bluetooth® transceivers, NFC transceivers, card readers or IR transceivers in the computer kiosk 130 may be in a ready state that can be activated by the presence of a hand held device, which may contain one or more wireless communication technologies. If the hand held device has multiple technologies the processor in the computer kiosk 130 may for example select the wireless communication technology that is most appropriate for use in the location within the store. For example, a wireless communication technology may be selected on the basis of the proximity of the mobile device to the computer kiosk as well as the potential for interference with the wireless signal. The computer kiosk 130 may select the appropriate wireless communication between the computer kiosk and the hand held device which is least likely to be intercepted by a third party. As an alternate the person with the hand held device may select the option of a direct connection through a USB port.

Thus, the invention in one example includes a method of enhancing a safe transfer of information comprising the steps of waving or placing a user device 12 having a central processing unit and a near field communication device proximate the visual display 13 having a near field communication region 17 to thereby initiate communication between the user device 12 and a processor which can generate a response on an electronic or visual display 13. In the next step information is exchanged between a consumer and processor 30c in the computer kiosk 10 with a response generated on the electronic or visual display 13 based on the consumer information communicated to processor 30c.

It will be found that the invention enables a neighborhood store to compete with on line marketers through use of an interactive display system 100 that includes an establishment 9 having at least one location for advertising goods and services; a control center 40 located remote from the establishment, a computer kiosk 10 in or proximate the establishment. The establishment includes an at least one electronic or visual display 13 for displaying consumer information in or proximate the establishment with the computer kiosk having a processor 30c, instore communication technology such as a near field communication transceiver 30d and a cellular chip 30e for wireless communication with a control center 40. The further part of the interactive display is the presence of a hand held device 12 which is independent of the establishment with the hand held device having a NFC chip or an NFC transceiver 12d for communicating consumer information to near field communication (NFC) transceiver 30d in the computer kiosk 10 by the physical action of bringing the hand held device 12 into NFC proximity with the NFC transceiver in the kiosk.

As described herein the method assists a neighborhood store 9 in competing with an online marketing service by allowing the neighborhood store to interact with the consumer and present special offers or individualized inducements for the consumer to purchase goods or services from the neighborhood store. In one example, one initiates a transfer of visual product or service information to a consumer 11 in the neighborhood store 9 by prompting the consumer to present a devices such as smartphone 12 having a processor and in store communication technology such as a near field communication chip to an instore computer kiosk 10 where the instore computer kiosk includes a processor 30c, an NFC chip in an NFC transceiver 30d and an NFC communication region 17 that enables a consumer to engage in NFC instore communication between the smartphone 12 and the kiosk 10 by bringing the smartphone proximate the NFC communication region 17. The computer kiosk 10 transfers information obtained from the NFC communication to the processor 30c in the kiosk. In response thereto the kiosk visual display 13 displays consumer information proximate the consumer 11 in the neighborhood store 9 in response to NFC communication from the smartphone NFC transceiver 12d and the NFC chip in the NFC transceiver 30d in the computer kiosk 10. The display presented to the consumer 11 may or may not be determined by a cellular signal from a remote control center 40. Although visual information is described the information supplied to the consumer may take other forms including audio or the like.

In another mode the invention comprises a method for providing consumer information using a remote control station and a cellular network to access an instore processor in a compute kiosk 10. The computer kiosk 10 having a visual display 13 with an NFC transceiver 30d, which can be accessed by a hand, held cellular device 12 by placing the hand held cellular device in NFC communication with the instore processor 30c. The information received from the hand held cellular device 12 is transmitted to the instore processor, which is in communication with an offsite processor 40c over cellular network 81, 82. The remote control station 40 responds to the communication between the instore processor 30c and the offsite processor 40c over the cellular network 81, 82 by sending a response communication over the cellular network. One then displays information 14 on the visual display 13 based on the response communication from the offsite processor to the instore processor over the cellular network 81,82.

In one example a cellular chip is uniquely associated with the visual display over a unique cellar frequency and the visual display can be individually and remotely controlled through a cellular communication from the remote control center the store to provide for individualized delivery of product information. In addition if the hand held device supplies data on the consumer for development of product or service related information the system can determine the relevancy of the related information based on information about the holder of the hand held device rather than the nature of the inquiry of the consumer thus providing the consumer with additional information to aid the consumer in his or her purchasing decision.

Thus the establishment of in store communication between a processor in a computer kiosk may be facilitated through a variety of technologies that limit the chances for theft of data including rf transmission technology in the 2400 to 2480 MHZ frequency range (i.e. Bluetooth) NFC technology, card reader technology, infra red technologies or cable technology.

I claim:

1. An interactive display system comprising:
an establishment having at least one location for advertising goods and services;
a control center located remote from said establishment;
a computer kiosk in or proximate said establishment;
an at least one visual display for displaying consumer information in or proximate said establishment with said computer kiosk having a processor, a transceiver for instore wireless communication and a cellular chip for cellular communication with said control center; and
a hand held device independent of the establishment with the hand held device engageable in store communication with the transceiver of said computer kiosk.

2. The interactive display system of claim 1 wherein said at least one visual display comprises a touch screen with the touch screen generating a prompt to induce a consumer to enter into communication with the kiosk.

3. The interactive display system of claim 1 including a cell tower for communication to and from a cellular chip in said kiosk and a cellular chip in said control center.

4. The interactive display system of claim 1 including a plurality of establishments with each of the plurality of establishments having a computer kiosk in cellular communication with the control center with the computer kiosk of each of the plurality of establishments have a cellular frequency unique thereto to enable the control center to individual recognize and communicate with each of computer kiosks in each of the plurality of establishments to display information that may or may not be the same as a information displayed to a computer kiosk in another of the plurality of establishments with each of the computer kiosks providing instore communication to and from the mobile hand held device.

5. The interactive display system of claim 4 wherein the hand held device comprises a smartphone with NFC capability and the computer kiosk has NFC capability to provide NFC communication therebetween by bringing the smartphone into proximity of the computer kiosk.

6. The interactive display system of claim 1 wherein the
the cellular chip is uniquely associated with the visual display over a unique cellar frequency whereby the visual display can be individually and remotely controlled through a cellular communication from the remote control center to provide for individualized delivery of product or service information and the hand held device supplies data on the consumer for development of product or service related information, where the relevancy of the related information is based on information about the consumer rather than the nature of the inquiry of the consumer.

7. The interactive display system of claim 3 wherein the kiosk includes a printer a speaker and an I/O device.

8. A method of aiding a consumer in a purchasing a product or service;
initiating a transfer of visual product or service information to the consumer in the neighborhood store by prompting the consumer to present a smartphone having a processor and a NFC chip to an instore computer kiosk in the neighborhood store where the instore computer kiosk includes a processor, an NFC chip and an NFC communication region that enables a consumer to engage in NFC communication between the smartphone and the kiosk by bringing the smartphone proximate the NFC communication region;
transferring consumer information to the computer kiosk through NFC communication to the processor in the kiosk; and
displaying consumer information on a visual display proximate the consumer in the neighborhood store in response to the NFC communication from the NFC transceiver in the smartphone and the NFC chip in the kiosk with the visual display presented to the consumer may or may not be determined by a cellular signal from a remote control center.

9. The method of claim 8 in aiding both a consumer and a neighborhood store in competition with an online marketing service wherein the NFC communication between the smartphone of the consumer and the visual display includes the step of directing the consumer to a website to provide the consumer with specific product or service information independent of the establishment.

10. The method of claim 8 in aiding either or both a consumer or a neighborhood store in competition with an online marketing service wherein the NFC communication between the smartphone and the computer kiosk includes the step of directing the information received from the NFC communication from the smartphone to the remote control center over a cellular network and the remote control center generates a product sales price unique to the customer through wireless communication on the cellular network.

11. The method of claim 8 in aiding either or both a consumer or a neighborhood store in competition with an online marketing service wherein the step of transferring information between the smartphone and the visual display includes exchanging information between a processor in the kiosk and a processor in the remote control center though a cellular network.

12. The method of claim 8 in aiding either or both a neighborhood store in competition with an online marketing service wherein the step of transferring information between a consumer and the visual display comprises using a touch screen on the instore computer kiosk to exchange information between the consumer and the visual display.

13. A method for providing consumer information using a cellular network comprising:
accessing an instore processor with a transceiver in a hand held cellular device by placing the hand held cellular device in instore communication with a transceiver in a computer kiosk;
transmitting the information received from the hand held cellular device to the instore processor;
communicating between the instore processor and an offsite processor over the cellular network;
responding to the communication between the instore processor and the offsite processor over the cellular network by sending a response communication over the cellular network; and
displaying information on a visual display, which is based on the response communication from the offsite processor to the instore processor.

14. The method of claim 13 including communicating between the offsite processor and another instore processor over a cellular network where the communication is based on geographical locations of the another instore processor and the in instore communication with the transceiver in the computer kiosk where the computer kiosk contains one or more instore communication technologies including rf transmission technology in the 2400 to 2480 MHZ frequency, NFC technology, card reader technology, infra red technologies or cable technology.

15. The method of claim 13 wherein a consumer supplies information to the instore processor through an I/O device on a cell phone.

16. The method of claim 13 wherein there are a plurality of instore processors and the communication between each of the plurality of instore processors and the remote processor is through a unique cellular frequency for each of the plurality of instore processors.
